(19) United States
(12) Patent Application Publication
(10) Pub. No.: US 2003/0180106 A1
(43) Pub. Date: Sep. 25, 2003

(54) Multiple hole-boring apparatus and method of use therefor

(76) Inventor: Stacy deWitt Russell, Dallas, GA (US)

Correspondence Address: MYERS & KAPLAN, INTELLECTUAL, PROPERTY LAW, L.L.C., 1827 POWERS FERRY ROAD, BUILDING 3, SUITE 200,, ATLANTA, GA, 30339, US

(21) Appl. No.: 10/101,143

(22) Filed: Mar. 19, 2002

(51) Int. Cl. B23B 35/00

(52) U.S. Cl. 408/1 R; 408/53; 408/110

(57) ABSTRACT

A multiple hole-boring apparatus and method of use therefor having multiple drill gears and idler gears in mechanical communication, wherein each drill gear possesses a drill bit and wherein each drill gear/drill bit combination is driven by the attachment of any drive means to the apparatus.

### TECHNICAL FIELD

The present invention relates generally to hole-boring devices, and more specifically to a multiple hole-boring apparatus and method of use therefor. The present invention is particularly useful for, although not strictly limited to, creating a plurality of aligned holes on materials utilized in the shelving and cabinetry-making industry, wherein such holes may serve to secure shelving support-pegs and/or dowels for the support of shelving thereon.

### BACKGROUND OF THE INVENTION

Typically, the inner and/or back walls/surfaces of most shelving units and/or cabinetry possess a plurality of aligned holes that function to primarily receive and secure shelving support-pegs/dowels, hangers and/or brackets therein. In turn, these support-pegs/dowels, hangers and/or brackets serve to support shelving boards placed thereon and to allow the adjustment of the level of the shelving boards as well. Although an effective method of creating and supporting shelving, producing a plurality of aligned and uniformly distanced holes for the ultimate support of such shelving can often prove to be an arduous and time-consuming task, especially considering the obvious consequences of ill-positioned and/or misaligned holes formed on opposing inner walls and/or the back wall of the shelving/cabinetry structure (i.e., slanted or uneven shelving units).

Generally, most available multiple hole-drilling machinery is usually large and complex and better suited for use in large manufacturing industries involved in mass production of shelving units. As such, individuals wishing to create shelving units within a home and/or add shelving boards to a preexisting shelving unit are often forced to utilize a hand-held, single hole-boring drill to create multiple holes, typically yielding misaligned and non-uniformly distanced holes, thus ultimately resulting in uneven or slanted shelving units.

Therefore, it is readily apparent that there is a need for a multiple hole-boring apparatus and method of use therefore for simultaneously drilling a plurality of aligned and uniformly distanced holes for receiving and securing shelving support-pegs/dowels, hangers and/or brackets therein for the support and adjustment of shelving boards placed thereon.

### BRIEF SUMMARY OF THE INVENTION

Briefly described, in a preferred embodiment, the present invention overcomes the above-mentioned disadvantages, and meets the recognized need for such a device by providing a multiple hole-boring apparatus and method of use therefore for simultaneously drilling a plurality of aligned and uniformly distanced holes for receiving and securing shelving support-pegs/dowels, hangers and/or brackets therein for the support and adjustment of shelving boards placed thereon.

According to its major aspects and broadly stated, the present invention in its preferred form is a multiple hole-boring apparatus and method of use therefore having multiple drill gears and idler gears in communication within one another, wherein each drill gear possesses a drill bit and wherein each drill gear/drill bit combination is driven by the attachment of any conventional reversible drill to the apparatus.

More specifically, the present invention is a multiple hole-boring apparatus and method of use therefore having multiple drill gears and idler gears in communication within one another and enclosed within a main housing or gearbox, wherein each drill gear possesses a removable drill bit that protrudes out of the gearbox. The gearbox further preferably possesses a universal driver in communication with preferably one of the drill gears, wherein attachment of any conventional reversible drill thereto and activation thereof permits the universal driver to be rotated and thus allows the gear in contact therewith to rotate, wherein rotation of that particular drill gear enables rotation of all other communicating drill gears via assistance from the idler gears. Rotation of the drill gears inherently results in rotation of the attached drill bits and hence the drilling of a plurality of aligned holes. Both the gearbox and a spacer are preferably slidably engaged with a first set of rails, wherein the spacer permits the gearbox to be distanced from the surface to be drilled at a specified height, thus determining the depth of the holes to be drilled. Moreover, the first set of rails are preferably slidably engaged with a second set of rails preferably perpendicular to the first set of rails, wherein sliding of the first set of rails along the second set of rails allows the gearbox to be positioned in such a manner that permits a plurality of aligned holes to be drilled any specified distance from the edge of the material/surface to be drilled and/or the formation of a plurality of aligned holes in parallel to another set of aligned holes.

A feature and advantage of the present invention is the ability to simultaneously drill a plurality of aligned and uniformly distanced holes in a single motion via any conventional reversible drill.

A feature and advantage of the present invention is the ability to accurately and consistently drill a plurality of aligned and uniformly distanced holes in parallel to another set of aligned and uniformly distanced holes.

A feature and advantage of the present invention is the ability to accurately and consistently drill a plurality of aligned and uniformly distanced holes perpendicular to another set of aligned and uniformly distanced holes.

A feature and advantage of the present invention is the ability to accurately and consistently drill a plurality of aligned and uniformly distanced holes at any angle to another set of aligned and uniformly distanced holes.

A feature and advantage of the present invention is its compactness, thus allowing for its use as an in-home tool in the construction of new cabinetry and/or shelving units or in the modification of pre-existing cabinetry and/or shelving units.

A feature and advantage of the present invention is its ease of use.

A feature and advantage of the present invention is its portability.

These and other objects, features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a perspective view of a multiple hole-boring apparatus according to a preferred embodiment of the invention.

FIG. 2 is a perspective view of the gearbox of a multiple hole-boring apparatus according to a preferred embodiment of the invention.

FIG. 3 is a cross-sectional top view of the gearbox of a multiple hole-boring apparatus according to a preferred embodiment of the invention.

FIG. 4 is a side view of the drill gears of a multiple hole-boring apparatus according to a preferred embodiment of the invention.

FIG. 5 is a side view of the idler gears of a multiple hole-boring apparatus according to a preferred embodiment of the invention.

FIG. 6 is a side view of the drill gears and idler gears of a multiple hole-boring apparatus according to a preferred embodiment of the invention.

FIG. 7 is a perspective view of a multiple hole-boring apparatus according to a preferred embodiment of the invention.

FIG. 8 is a perspective view of a multiple hole-boring apparatus according to a preferred embodiment of the invention.

FIG. 9 is a perspective view of the first set of rails of a multiple hole-boring apparatus according to a preferred embodiment of the invention.

FIG. 10 is a perspective view of the first set of rails of a multiple hole-boring apparatus according to a preferred embodiment of the invention.

FIG. 11 is a perspective view of a multiple hole-boring apparatus according to a preferred embodiment of the invention shown in use.

### DETAILED DESCRIPTION OF THE PREFERRED AND ALTERNATIVE EMBODIMENTS

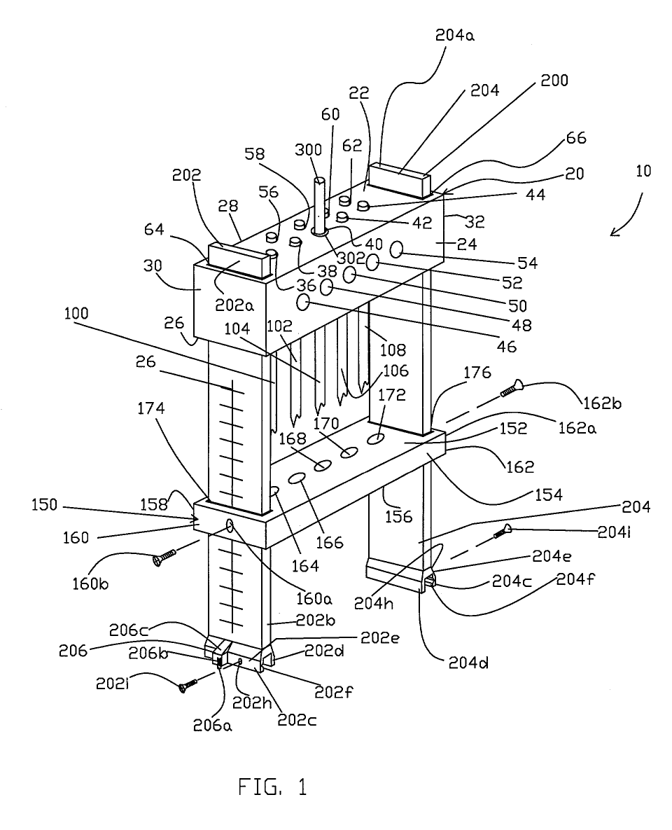

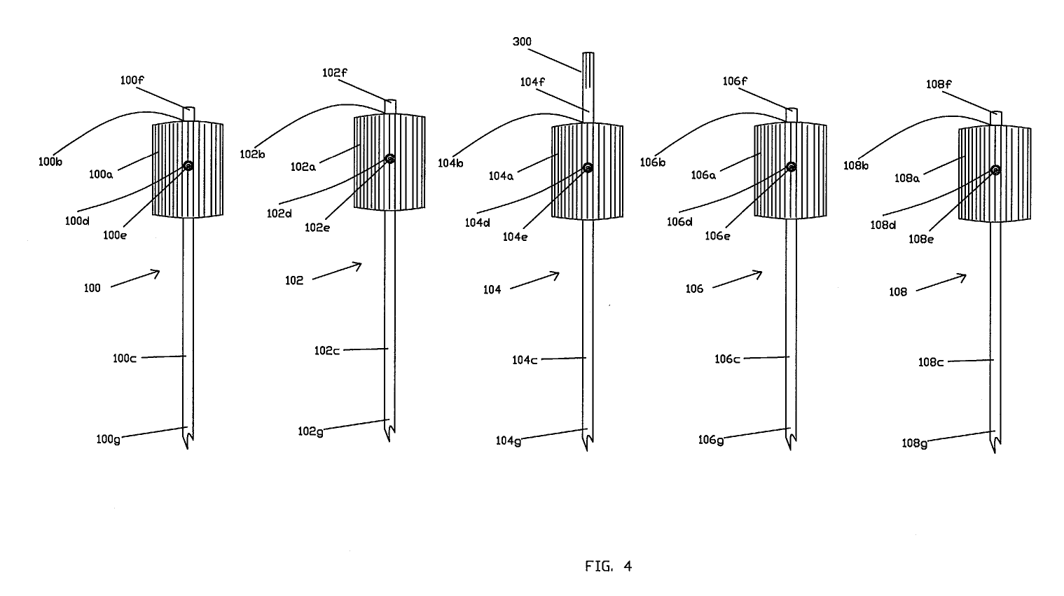

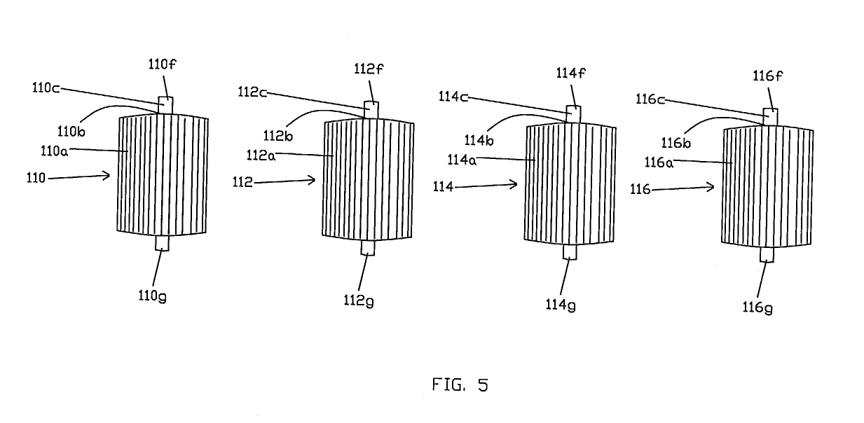

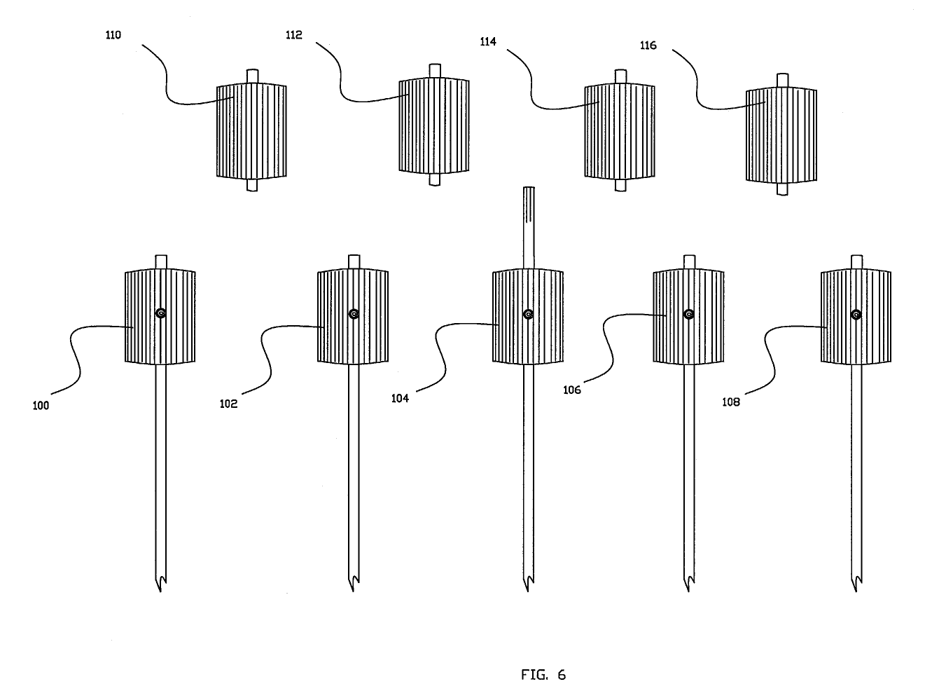

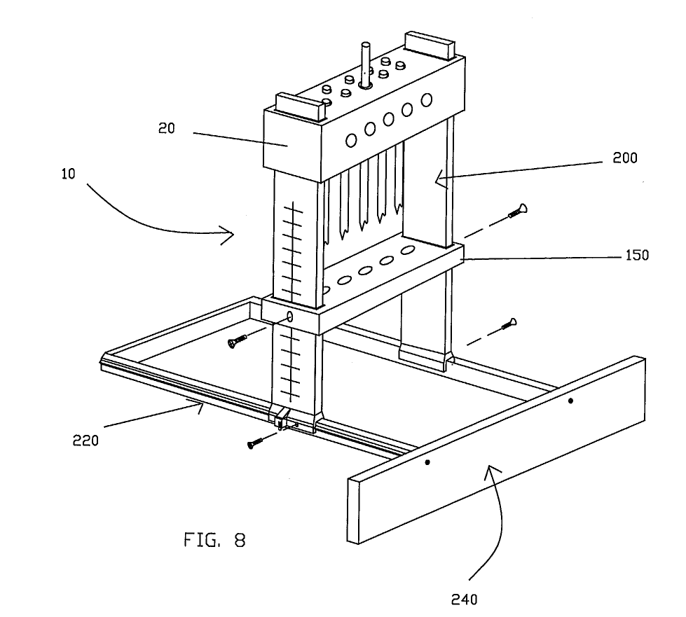

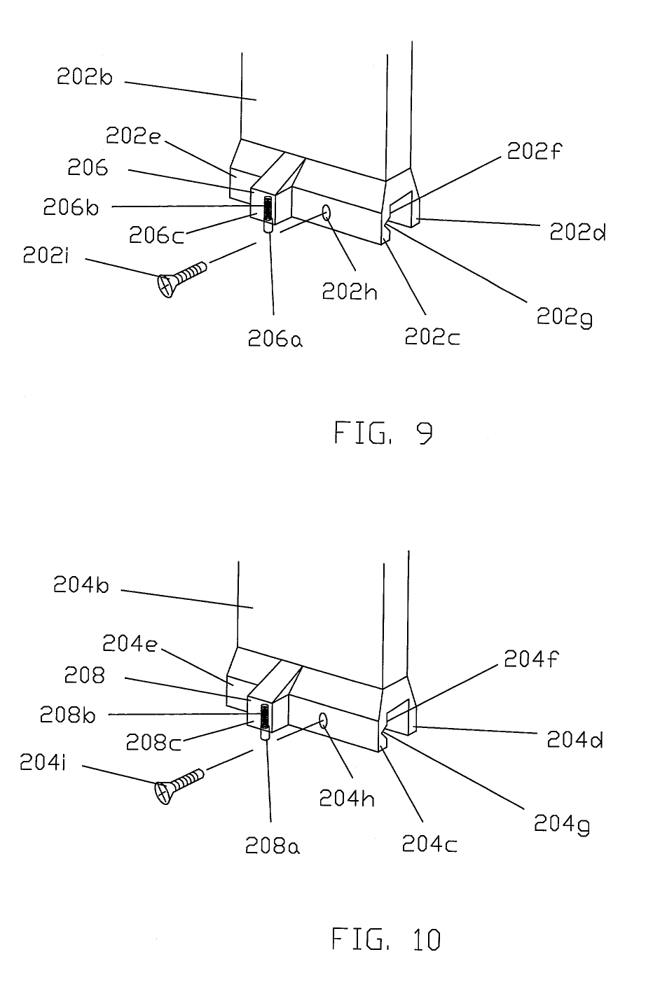

In describing the preferred and alternate embodiments of the present invention, as illustrated in FIGS. 1-11, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-3, the present invention in its preferred embodiment is an apparatus 10, wherein apparatus 10 is a multiple hole-boring apparatus generally having a gear box 20, a spacer 150, a first set of rails 200, a second set of rails 220 and a guide member 240.

Gear box 20 is preferably rectangular-shaped and has a first side 22, a second side 24, a third side 26, a fourth side 28, a fifth side 30 and a sixth side 32. Gearbox 20 is preferably formed from a plastic material; although other suitable material may be used. Gear box 20 further preferably possesses equally distanced throughholes 36, 38, 40, 42 and 44 formed on first side 22 of gear box 20 and preferably equally distanced throughholes 36a, 38a, 40a, 42a and 44a formed on third side 26, wherein throughholes 36a, 38a, 40a, 42a and 44a are aligned with throughholes 36, 38, 40, 42 and 44, respectively, of first side 22, and wherein throughholes 36, 38, 40, 42 and 44 and throughholes 36a, 38a, 40a, 42a and 44a preferably receive the axles of the drill gears as more fully described below. Fourth side 24 has preferably formed thereon apertures 46, 48, 50, 52 and 54, wherein apertures 46, 48, 50, 52 and 54 preferably permit access to the set screws of the drill gears as more fully described below. Formed on first side 22 and preferably positioned parallel to throughholes 36, 38, 40, 42 and 44 are preferably equally distanced throughholes 56, 58, 60 and 62, wherein throughholes 56, 58, 60 and 62 are preferably respectively aligned with preferably equally distanced throughholes 56a, 58a, 60a and 62a, formed on third side 26 and positioned preferably parallel to throughholes 36a, 38a, 40a, 42a and 44a of third side 26. Throughholes 56, 58, 60 and 62 and throughholes 56a, 58a, 60a and 62a preferably receive the axles of the idler gears as more fully described below. Throughholes 36, 38, 40, 42, 44, 36a, 38a, 40a, 42a, 44a, 56, 58, 60, 62, 56a, 58a, 60a, 62a and apertures 46, 48, 50, 52 and 54 are all preferably in communication with internal space 70 of gear box 20.

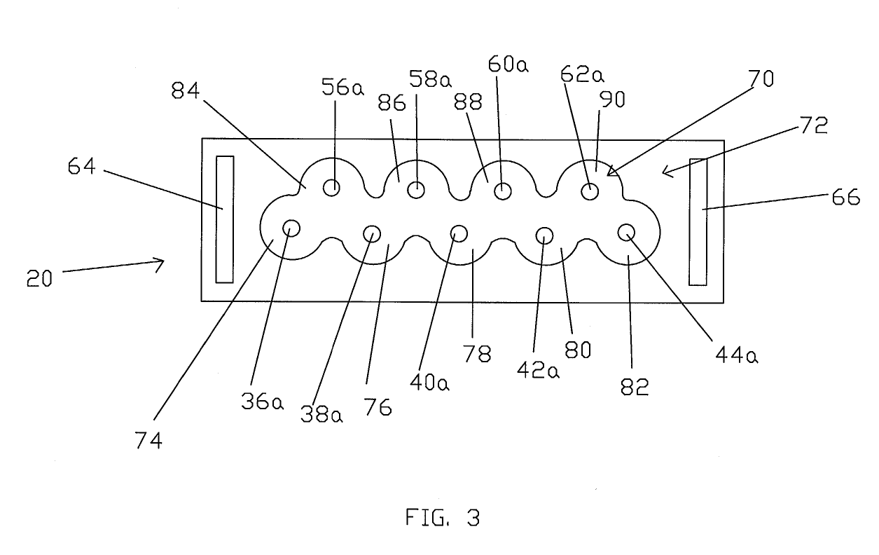

Referring specifically now to FIG. 3, internal space 70 of gear box 20 is preferably defined by a pre-formed structure 72, wherein pre-formed structure 72 preferably possesses generally substantially semi-circular recesses 74, 76, 78, 80 and 82, wherein recesses 74, 76, 78 80 and 82 preferably receive drill gears as more fully described below. Pre-formed structure 72 further preferably possesses generally substantially semicircular recesses 84, 86, 88 and 90, wherein recesses 84, 86, 88 and 90 preferably receive idler gears as more fully described below. Recesses 74, 76, 78 80 and 82 and recesses 84, 86, 88 and 90 are preferably in communication with one another, thus forming the multi-bulbous shape of internal space 70.

Referring now to FIGS. 3-6, internal space 70 of gear box 20 preferably houses first drill gear assembly 100, second drill gear assembly 102, third drill gear assembly 104, fourth drill gear assembly 106 and fifth drill gear assembly 108, and further houses first idler gear assembly 110, second idler gear assembly 112, third idler gear assembly 114 and fourth idler gear assembly 116. Specifically, first drill gear assembly 100 possesses drill gear 100a, channel 100b and drill bit 100c, wherein drill bit 100c recesses into channel 100b such that drill gear 100a is positioned proximal to end 100f of drill bit 100c, opposite and substantially distanced from boring end 100g of drill bit 100c, thus enabling drill bit 100c to serve as an axle for rotation of first drill assembly 100 within gear box 20. Drill gear 100a further preferably possesses centrally positioned threaded aperture 100d formed preferably perpendicular to channel 100b of first gear assembly 100 and in communication therewith, wherein threaded aperture 100d preferably receives a setscrew 10e that preferably functions to removably secure drill bit 100c within channel 100b of drill bit 100a of first drill gear assembly 100.

Second drill gear assembly 102 possesses drill gear 102a, channel 102b and drill bit 102c, wherein drill bit 102c recesses into channel 102b such that drill gear 102a is positioned proximal to end 102f of drill bit 102c, opposite and substantially distanced from boring end 102g of drill bit 102c, thus enabling drill bit 102c to serve as an axle for rotation of second drill assembly 102 within gear box 20. Drill gear 102a further preferably possesses centrally positioned threaded aperture 102d formed preferably perpendicular to channel 102b of second gear assembly 102 and in communication therewith, wherein threaded aperture 102d preferably receives a setscrew 102e that preferably functions to removably secure drill bit 102c within channel 102b of drill bit 102a of second drill gear assembly 102.

Third drill gear assembly 104 possesses drill gear 104a, channel 104b and drill bit 104c, wherein drill bit 104c recesses into channel 104b such that drill gear 104a is positioned proximal to end 104f of drill bit 104c, opposite and substantially distanced from boring end 104g of drill bit 104c, thus enabling drill bit 104c to serve as an axle for rotation of third drill assembly 104 within gear box 20. Drill gear 104a further preferably possesses centrally positioned threaded aperture 104d formed preferably perpendicular to channel 104b of third gear assembly 104 and in communication therewith, wherein threaded aperture 104d preferably receives a setscrew 104e that preferably functions to removably secure drill bit 104c within channel 104b of drill bit 104a of third drill gear assembly 104.

Fourth drill gear assembly 106 possesses drill gear 106a, channel 106b and drill bit 106c, wherein drill bit 106c recesses into channel 106b such that drill gear 106a is positioned proximal to end 106f of drill bit 106c, opposite and substantially distanced from boring end 106g of drill bit 106c, thus enabling drill bit 106c to serve as an axle for rotation of fourth drill assembly 106 within gear box 20. Drill gear 106a further preferably possesses centrally positioned threaded aperture 106d formed preferably perpendicular to channel 106b of fourth gear assembly 106 and in communication therewith, wherein threaded aperture 106d preferably receives a setscrew 106e that preferably functions to removably secure drill bit 106c within channel 106b of drill bit 106a of fourth drill gear assembly 106.

Fifth drill gear assembly 108 possesses drill gear 108a, channel 108b and drill bit 108c, wherein drill bit 108c recesses into channel 108b such that drill gear 108a is positioned proximal to end 108f of drill bit 108c, opposite and substantially distanced from boring end 108g of drill bit 108c, thus enabling drill bit 108c to serve as an axle for rotation of fifth drill assembly 108 within gear box 20. Drill gear 108a further preferably possesses centrally positioned threaded aperture 108d formed preferably perpendicular to channel 108b of fifth gear assembly 108 and in communication therewith, wherein threaded aperture 108d preferably receives a setscrew 108e that preferably functions to removably secure drill bit 108c within channel 108b of drill bit 108a of fifth drill gear assembly 108.

End 104f of drill gear 104c of third drill assembly 104 is preferably substantially longer in length as compared to ends 100f, 102f, 106f and 108f of drill gears 100c, 102c, 106c and 108c, respectively, of drill gear assemblies 100, 102, 106 and 108, respectively. Specifically, end 104f of drill gear 104c is preferably multi-sided and functions preferably as a universal driver 300 as more fully discussed below.

First idler gear assembly 110 possesses idler gear 110a, channel 110b and axle 110c, wherein axle 110c recesses into channel 110b such that idler gear 110a is substantially centered between ends 110f and 110g of axle 110c, thus enabling axle 110c to serve as an axis of rotation for first idler gear assembly 110 within gear box 20.

Second idler gear assembly 112 possesses idler gear 112a, channel 112b and axle 112c, wherein axle 112c recesses into channel 112b such that idler gear 112a is substantially centered between ends 112f and 112g of axle 112c, thus enabling axle 112c to serve as an axis of rotation for second idler gear assembly 112 within gear box 20.

Third idler gear assembly 114 possesses idler gear 114a, channel 114b and axle 114c, wherein axle 114c recesses into channel 114b such that idler gear 114a is substantially centered between ends 114f and 114g of axle 114c, thus enabling axle 114c to serve as an axis of rotation for third idler gear assembly 114 within gear box 20.

Fourth idler gear assembly 116 possesses idler gear 116a, channel 116b and axle 116c, wherein axle 116c recesses into channel 116b such that idler gear 116a is substantially centered between ends 116f and 116g of axle 116c, thus enabling axle 116c to serve as an axis of rotation for fourth idler gear assembly 116 within gear box 20.

Recesses 74, 76, 78, 80 and 82 of internal space 70 of gear box 20 preferably receives first drill gear assembly 100, second drill gear assembly 102, third drill gear assembly 104, fourth drill gear assembly 106 and fifth drill gear assembly 108, respectively. Specifically, end 100g of drill bit 100c of first drill gear assembly 100 is received through throughhole 36a of third side 26 of gear box 20 and end 100f is received through throughhole 36 of first side 22 of gear box 20, thus allowing rotation of first drill gear assembly 100 therein. End 102g of drill bit 102c of second drill gear assembly 102 is received through throughhole 38a of third side 26 of gear box 20 and end 102f is received through throughhole 38 of first side 22 of gear box 20, thus allowing rotation of second drill gear assembly 102 therein. End 104g of drill bit 104c of third drill gear assembly 104 is received through throughhole 40a of third side 26 of gear box 20 and end 104f is received through throughhole 40 of first side 22 of gear box 20, thus allowing rotation of third drill gear assembly 104 therein. End 106g of drill bit 106c of fourth drill gear assembly 106 is received through throughhole 42a of third side 26 of gear box 20 and end 106f is received through throughhole 42 of first side 22 of gear box 20, thus allowing rotation of fourth drill gear assembly 106 therein. End 108g of drill bit 108c of third drill gear assembly 108 is received through throughhole 44a of third side 26 of gear box 20 and end 108f is received through throughhole 44 of first side 22 of gear box 20, thus allowing rotation of fifth drill gear assembly 108 therein.

Recesses 84, 86, 88 and 90 of internal space 70 of gear box 20 preferably receives first idler gear assembly 110, second idler gear assembly 112, third idler gear assembly 114 and fourth idler gear assembly 116, respectively. Specifically, end 110g of axle 110c of first idler gear assembly 110 is received through throughhole 56a of third side 26 of gear box 20 and end 110f is received through throughhole 56 of first side 22 of gear box 20, thus allowing rotation of first idler gear assembly 110 therein. End 112g of axle 112c of second idler gear assembly 112 is received through throughhole 58a of third side 26 of gear box 20 and end 112f is received through throughhole 58 of first side 22 of gear box 20, thus allowing rotation of second idler gear assembly 110 therein. End 114g of axle 114c of third idler gear assembly 114 is received through throughhole 60a of third side 26 of gear box 20 and end 114f is received through throughhole 60 of first side 22 of gear box 20, thus allowing rotation of third idler gear assembly 114 therein. End 116g of axle 116c of fourth idler gear assembly 116 is received through throughhole 62a of third side 26 of gear box 20 and end 116f is received through throughhole 62 of first side 22 of gear box 20, thus allowing rotation of fourth idler gear assembly 116 therein.

Preferably, when positioned and housed with gear box 20, the teeth of drill gear 100a of first drill gear assembly 100 are in communication with the teeth of idler gear 110a of first idler gear assembly 110; the teeth of idler gear 110a are further preferably in communication with the teeth of drill gear 102a of second drill gear assembly 100; the teeth of drill gear 102a are further preferably in communication with the teeth of idler gear 112a of second idler gear assembly 112; the teeth of idler gear 112a are further preferably in communication with the teeth of drill gear 104a of third drill gear assembly 104; the teeth of drill gear 104a are further preferably in communication with the teeth of idler gear 114a of third idler gear assembly 114; the teeth of idler gear 114a are further preferably in communication with the teeth of drill gear 106a of fourth drill gear assembly 106; the teeth of drill gear 106a are further preferably in communication with the teeth of idler gear 116a of fourth idler gear assembly 116 and; the teeth of idler gear 116a are further preferably in communication with the teeth of drill gear 108a of fifth drill gear assembly 108. As such, because the lengthy end 104f of drill bit 104c serves as universal driver 300, rotation of universal driver 300 via attachment to a universal drill results in the rotation of third gear assembly 104 and thus effects a rotation over all communicating drill and idler gears, thereby enabling boring ends 100g, 102g, 104g, 106g and 108g of drill bits 100c, 102c, 104c, 106c and 108c, respectively, to bore holes in a surface. The teeth of all drill and idler gears are preferably formed parallel to fifth side 30 and sixth side 32 of gear box 20. Moreover, to facilitate the movement of the gears past one another, a lubricant or grease is preferably applied to the surface of all drill and idler gears. Finally, a bushing 302 can be placed around throughhole 40 of first side 26 of gear box 20, wherein bushing 302 would prevent the degradation of the material surrounding throughhole 40 when a reversible drill is attached to universal driver 300 and operated in closed proximity thereto. Although five drill gear assemblies and four idler gear assemblies are preferred, it is contemplated in an alternate embodiment that apparatus 10 could possess any number of drill gears and/or idler gear assemblies.

In the event that a user of apparatus 10 wishes to replace drill bits 100c, 102c, 104c, 106c and 108c of drill gear assemblies 100, 102, 104, 106 and 108, respectively, apertures 46, 48, 50, 52 and 54 of fourth side 24 of gear box 20 permit the user to access and remove setscrews 100e, 102e, 104e, 106e and 108e of drill gears 100a, 102a, 104a, 106a and 108a, respectively, from threaded apertures 100d, 102d, 104d, 106d and 108d, respectively. Upon removal of setscrews 100e, 102e, 104e, 106e and 108e, drill bits 100c, 102c, 104c, 106c and 108c, respectively are released from channels 100b, 102b, 104b, 106b and 108b and may be subsequently exchanged with another set of drill bits, wherein the new set of drill bits are secured therein via replacement of setscrews 100e, 102e, 104e, 106e and 108e.

Gear box 20 further preferably possesses rectangular-shaped slots 64 and 66, wherein slots 64 and 66 are preferably positioned proximal to fifth side 30 and sixth side 32, respectively, of gear box 20 and are preferably formed through first side 22 and extend through third side 26 of gear box 20. As more fully discussed below, slots 64 and 68 preferably function to permit gear box 20 to be slidably engaged with rectangular-shaped first rail 202 and rectangular-shaped second rail 204, respectively, of first set of rails 200.

Preferably positioned below gear box 20 is spacer 150, wherein spacer 150 is a preferably thin rectangular-shaped member and has a first side 152, a second side 154, a third side 156, a fourth side 158, a fifth side 160 and a sixth side 162. Spacer 150 is preferably formed from a plastic material; although other suitable material may be used. Spacer 150 further preferably possesses equally distanced throughholes 164, 166, 168, 170 and 172 formed through first side 152 and into third side 156, wherein throughholes 164, 166, 168, 170 and 172 are preferably aligned with drill bits 100c, 102c, 104c, 106c and 108c, respectively, thus allowing access of the same therethrough.

Spacer 150 further preferably possesses rectangular-shaped slots 174 and 176, wherein slots 174 and 176 are preferably positioned proximal to fifth side 160 and sixth side 162, respectively, of spacer 150 and are preferably formed through first side 152 and extend through third side 156 of spacer 150. As more fully discussed below, slots 174 and 176 preferably function to permit spacer 150 to be slidably engaged with first rail 202 and second rail 204, respectively, of first set of rails 200.

Fifth side 160 and sixth side 162 of spacer 150 preferably possess throughholes 160a and 162a, respectively, centrally positioned and formed thereon, wherein throughholes 160a and 162a preferably permit setscrews 160b and 162b, respectively, to be inserted therethrough so as to enable spacer 150 to be secured at a predetermined height along the length of first set of rails 200 by tightening setscrews 160b and 162b against first rail 202 and second rail 204, respectively, of first set of rails 200, wherein first rail 202 and second rail 204 preferably possess graduated markings 500 representative of common measuring systems.

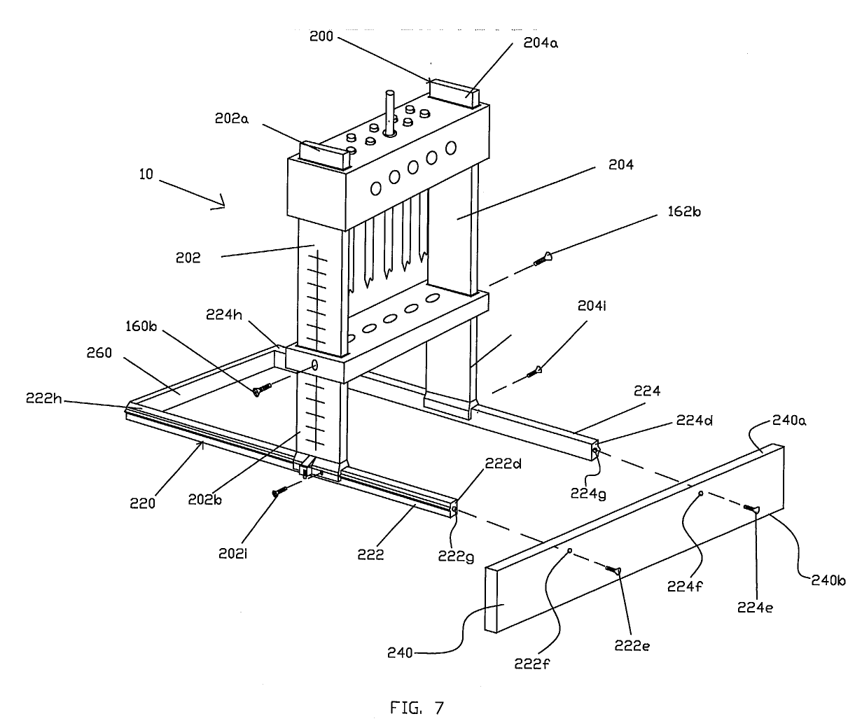

Referring now to FIGS. 7-10, first rail 202 and second rail 204 of first set of rails 200 are preferably generally substantially rectangular, wherein first rail 202 has ends 202a and 202b and second rail 204 preferably has ends 204a and 204b. Ends 202b and 204b of first rail 202 and second rail 204, respectively, are preferably tong-shaped so as to permit first rail 202 and second rail 204 to be slidably engaged with second set of rails 220. Specifically, end 202b has first tong arm 202c and second tong arm 202d, wherein tong arm 202c has outer wall 202e and inner wall 202f. Preferably, inner wall 202f has V-shaped channel 202g running along the entire length of tong-arm 202c of end 202b of first rail 202, wherein channel 202g slidably engages a V-shaped ridge on second set of rails 220 as fully discussed below. Similarly, end 204b has first tong arm 204c and second tong arm 204d, wherein tong arm 204c has outer wall 204e and inner wall 204f. Preferably, inner wall 204f has V-shaped channel 204g running along the entire length of tong-arm 204c of end 204b of first rail 204, wherein channel 204g slidably engages a V-shaped ridge on second set of rails 220 as fully discussed below.

Formed preferably through outer wall 202e of first tong arm 202c of end 202b of first rail 202 is threaded throughhole 202h, wherein threaded throughhole 202h preferably receives a setscrew 202i that permits first rail 202 of first set of rails 200 to be releaseably secured to a first sliding rail 222 of second set of rails 220. Similarly, formed preferably through outer wall 204e of first tong arm 204c of end 204b of second rail 204 is threaded throughhole 204h, wherein threaded throughhole 204h preferably receives a setscrew 204i that permits second rail 204 of first set of rails 200 to be releaseably secured to a second sliding rail 224 of second set of rails 220.

Formed preferably proximal to ends 202b and 204b of first rail 202 and second rail 204, respectively, of first set of rails 200 are spring-loaded guiders 206 and 208, respectively, wherein guider 206 preferably has a peg 206a, a spring 206b and a housing 206c enclosing both peg 206a and spring 206b, and wherein guider 208 preferably has a peg 208a, a spring 208b and a housing 208c enclosing both peg 208a and spring 208b. Guiders 206 and 208 preferably function to allow apparatus 10 to drill a plurality of holes in alignment with holes previously drilled by apparatus 10 by inserting peg 206a (or peg 208a depending upon the orientation of apparatus 10) into the last hole drilled by apparatus 10 and then subsequently drilling another set of holes. For purposes of uniformly distancing each drilled hole from one another, the distance between the tip of peg 206a and the tip of boring end 100g of first drill gear assembly 100 is preferably equal to the distance between the tips of any two adjacent boring ends 100g, 102g, 104g, 106g and 108g of drill gear assemblies 100, 102, 104, 106 and 108, respectively. Similarly, for purposes of uniformly distancing each drilled hole from one another, the distance between the tip of peg 208a the tip of boring end 108g of fifth drill gear assembly 108 is preferably equal to the distance between the tips of any two adjacent boring ends 100g, 102g, 104g, 106g and 108g of drill gear assemblies 100, 102, 104, 106 and 108, respectively. If no holes have been previously drilled, pushing apparatus 10 against a surface to be drilled forces pegs 206a and 208a to recess within their respective housings 206c and 208c via attached springs 206b and 208b, respectively.

Second set of rails 220 preferably has rectangular-shaped first sliding rail 222 and rectangular-shaped second sliding rail 224, wherein first sliding rail 222 and second sliding rail 224 are preferably parallel to one another and preferably perpendicular to first set of rails 200. First sliding rail 222 and second sliding rail 224 are also preferably distanced from one another at a distance equal to the distance between first rail 202 and second rail 204 of first set of rails 200 so as to permit first rail 202 and second rail 204 of first set of rails 200 to slidably engage first sliding rail 222 and second sliding rail 224, respectively, of second set of rails 220 via tong-shaped ends 202b and 204b, respectively, of first rail 202 and second rail 204, respectively of first set of rails 200. Specifically, first sliding rail 222 has an inner wall 222a and an outer wall 222b, wherein outer wall 222b possesses a V-shaped ridge 222c that runs the length of first sliding rail 222 and is dimensioned to slidably receive V-shaped channel 202g of first rail 202 of first set of rails 200. Similarly, second sliding rail 224 has an inner wall 224a and an outer wall 224b, wherein outer wall 224b possesses a V-shaped ridge 224c that runs the length of second sliding rail 224 and is dimensioned to slidably receive V-shaped channel 204g of second rail 204 of first set of rails 200. Engagement of the relative ridges and channels permits first set of rails 200 and second set of rails 220 to be slidably engaged with one another, wherein upon engagement, only second set of rails actually contacts the surface to be drill.

Preferably removably secured at ends 222d and 224d of first sliding rail 222 and second sliding rail 224, respectively, of second set of rails 220 is guide member 240, wherein guide member 240 is preferably perpendicular to first sliding rail 222 and second sliding rail 224 and is preferably a rectangular-shaped plate. Ends 222d and 224d of first sliding rail 222 and second sliding rail 224, respectively, are preferably removably secured proximal to edge 240a of guide member 240, opposite edge 240b of guide member 240 via insertion of screws 222e and 224e into throughholes 222f and 224f, respectively, of guide member 240 and thereafter into holes 222g and 224g, respectively formed in ends 222d and 224d, respectively, of first sliding rail 222 and second sliding rail 224, respectively. Guide member 240 preferably functions to corner or brace the edge of a surface or wall to be drill and thus guide apparatus 10 along the surface is a consistently accurate and aligned manner. As such, guide member 240 can be removed therefrom and reversed or replaced in a more accommodating position

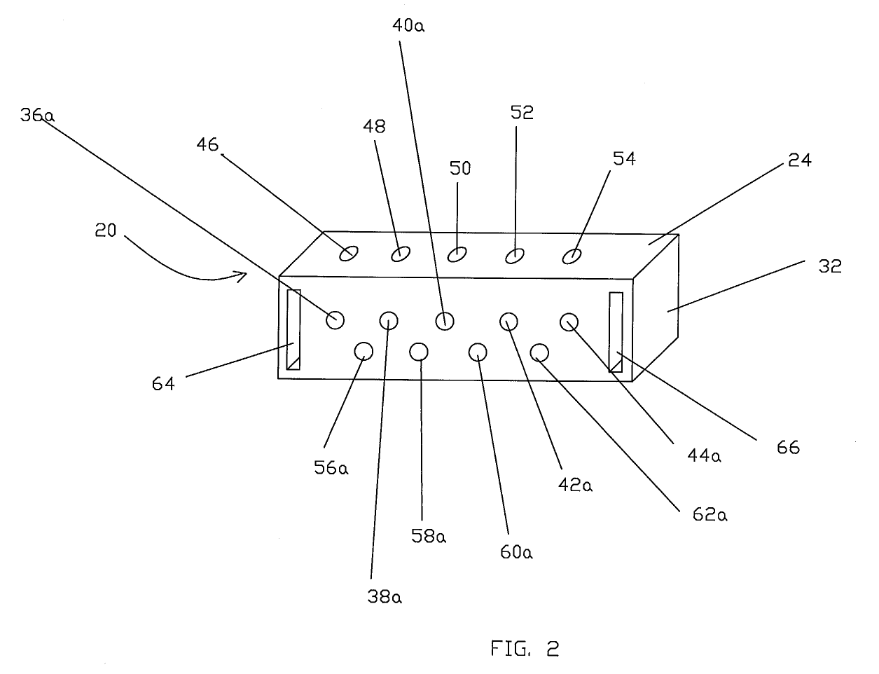

Ends 222h and 224h of first sliding rail 222 and second sliding rail 224, respectively, of second set of rails 220 have preferably attached thereto bar 260, wherein bar 260 is preferably perpendicular to first sliding rail 222 and second sliding rail 224. As depicted in FIGS. 1-2, second set of rails 220 and attached guide member 240 can be removed completely from apparatus 10 by detaching second set of rails 220 from first set of rails 200 via removal of second set of rails 220 from ends 202b and 204b of first set of rails 200, thus allowing use of apparatus 10 on any surface or in any structure.

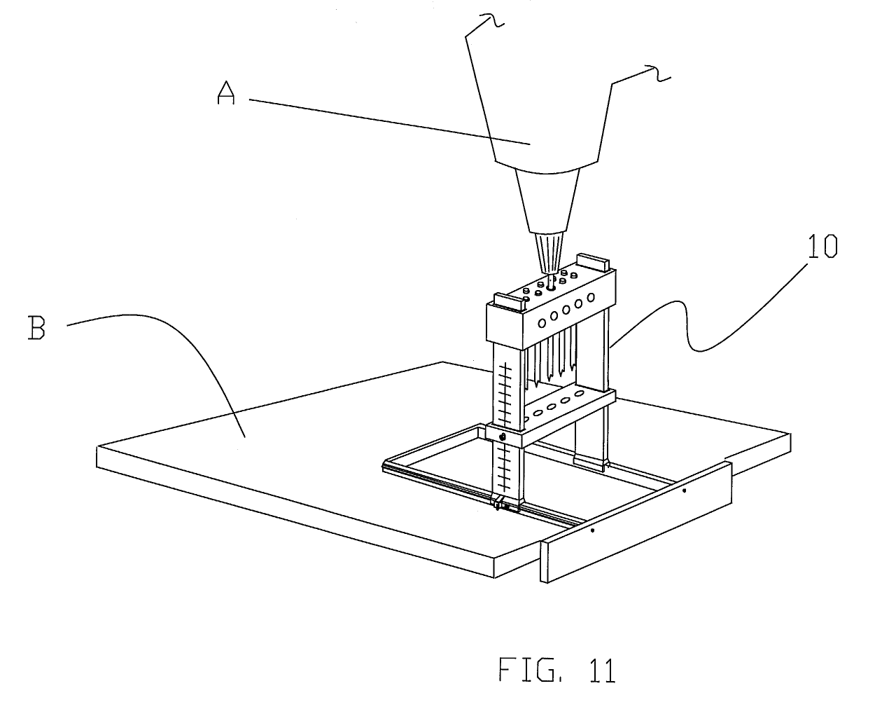

Referring now FIG. 11, in use, apparatus 10 is placed against a surface or wall B and a reversible drill A is attached to universal driver 300 of gear box 20. Pushing drill A against gear box 20 results in gear box 20 sliding down first set of rails 200 via slots 64 and 66 of gear box 20. When gear box 20 contacts spacer 150, boring ends 100g, 102g, 104g, 106g and 108g of drill assemblies 100, 102, 104, 106 and 108, respectively, enter through throughholes 164, 166, 168, 170 and 172 of spacer 150, resulting in boring ends 100g, 102g, 104g, 106g and 108g contacting the surface to be drilled and boring holes therein via activation of drill A.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A multiple hole-boring apparatus, comprising:
at least one support member;
means for carrying a plurality of hole-boring tools, said carrying means slidably engaged with said at least one support member; and
means for synchronizing the rotation of said plurality of hole-boring tools.

2. The multiple hole-boring apparatus of claim 1, further comprising a spacer carried by said at least one support member.

3. The multiple hole-boring apparatus of claim 1, wherein said carrying means is an enclosure.

4. The multiple hole-boring apparatus of claim 1, wherein said means for synchronizing is at least one gear.

5. The multiple hole-boring apparatus of claim 4, wherein said at least one gear is carried within said enclosure.

6. The multiple hole-boring apparatus of claim 1, wherein said at least one support member comprises a first rail and a second rail spaced-apart from each other, and wherein said carrying means is slidably engaged between said first rail and said second rail.

7. The multiple hole-boring apparatus of claim 1, further comprising means for positioning and guiding said means for carrying.

8. The multiple hole-boring apparatus of claim 7, wherein said means for positioning and guiding comprises a first guide rail, a second guide rail and a guide member, wherein said guide member is attached to said first guide rail and said second guide rail.

9. The multiple hole-boring apparatus of claim 8, wherein said first guide rail and said second guide rail are generally parallel, and wherein said guide member is removably attached.

10. A multiple hole-boring apparatus, comprising:
at least one support member;
means for carrying a plurality of hole-boring tools, said carrying means slidably engaged with said at least one support member; and
at least one gear engaged to mechanically communicate with and synchronize the rotation of said plurality of hole-boring tools.

11. The multiple hole-boring apparatus of claim 10, further comprising a spacer carried by said at least one support member.

12. The multiple hole-boring apparatus of claim 10, wherein said carrying means is an enclosure.

13. The multiple hole-boring apparatus of claim 10, wherein said at least one gear is carried within said enclosure.

14. The multiple hole-boring apparatus of claim 10, wherein said at least one support member comprises a first rail and a second rail spaced-apart from each other, and wherein said carrying means is slidably engaged between said first rail and said second rail.

15. The multiple hole-boring apparatus of claim 10, further comprising means for positioning and guiding said means for carrying.

16. The multiple hole-boring apparatus of claim 15, wherein said means for positioning and guiding comprises a first guide rail, a second guide rail and a guide member, wherein said guide member is attached to said first guide rail and said second guide rail.

17. The multiple hole-boring apparatus of claim 16, wherein said first guide rail and said second guide rail are generally parallel, and wherein said guide member is removably attached.

18. A method of utilizing a drive means to form multiple holes in a surface, comprising the steps of:
a. obtaining an assembly comprising a plurality of hole-boring tools in mechanical communication via at least one gear;
b. attaching the drive means to at least one of said plurality of hole-boring tools;
c. rotating said at least one of said plurality of hole-boring tools via the drive means to thus rotate all of said plurality of hole-boring tools via said at least one gear; and
d. contacting said plurality of hole-boring tools to the surface.
